(19) United States
(12) Patent Application Publication
(10) Pub. No.: US 2024/0151196 A1
(43) Pub. Date: May 9, 2024

(54) SYSTEMS FOR A HYDRAULIC CIRCUIT

(71) Applicant: Dana Motion Systems Italia S.R.L., Reggio Emilia (IT)

(72) Inventors: Luca BUSCICCHIO, Modena (IT); Piergiorgio TRINCHIERI, Reggio Emilia (IT)

(21) Appl. No.: 18/502,959

(22) Filed: Nov. 6, 2023

Related U.S. Application Data
(60) Provisional application No. 63/382,639, filed on Nov. 7, 2022.

(51) Int. Cl. F02M 37/10; F02M 37/00; F02M 37/50

(52) U.S. Cl. CPC F02M 37/106; F02M 37/0052; F02M 37/103; F02M 37/50

(57) ABSTRACT

Systems are provided for a mobile asset. In one example, a gear pump coupled to an electric motor and a tank, the gear pump comprising an end cover with a hydraulic integrated circuit (HIC) arranged therein. A shaft extending from the electric motor to the gear pump is housed via only an electric motor housing and the end cover.

### CROSS REFERENCE TO RELATED APPLICATION

The present application claims priority to U.S. Provisional Application No. 63/382,639, entitled “SYSTEMS FOR A HYDRAULIC CIRCUIT”, and filed on Nov. 7, 2022. The entire contents of the above-listed application are hereby incorporated by reference for all purposes.

### TECHNICAL FIELD

The present description relates generally to a hydraulic circuit of a mobile asset.

### BACKGROUND AND SUMMARY

Mobile assets may utilize hydraulic circuits for operating one or more systems outside of propulsion. The hydraulic circuits may include a motor, a pump, a tank, and a hydraulic integrated circuit (HIC) for executing various functions. However, hydraulic circuits may increase packaging constraints and may face manufacturing challenges due to various flow rates desired for differing functions. Additionally, pressure drops along with oil contamination and/or oil leakage may be associated with larger hydraulic circuits currently in manufacture.

In one example, the issues described above may be at least partially solved by a system for a gear pump coupled to an electric motor and a tank, the gear pump comprising an end cover with a hydraulic integrated circuit (HIC) arranged therein. By doing this, a size of the system may be reduced, which may mitigate oil leaks and/or contamination. Additionally, pressure drops may be reduced.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

The above, as well as other advantages of the present disclosure, will become readily apparent to those skilled in the art from the following detailed description when considered in light of the accompanying drawings in which:

FIG. 1 is a first example of a drivetrain of a mobile asset, according to an embodiment of the present disclosure;

FIG. 2 is a second example of a drivetrain of a mobile asset, according to an embodiment of the present disclosure;

FIG. 3A is a first example of a hydraulic system arranged in a mobile asset, according to an embodiment of the present disclosure;

FIG. 3B is a second example of a hydraulic system arranged in a mobile asset, according to an embodiment of the present disclosure;

FIG. 4A is a schematic for a hydraulic system of a first type of the mobile asset according to embodiments of the present disclosure;

FIG. 4B is a schematic for a hydraulic system of a second type of the mobile asset;

FIGS. 5A-5F are various views of the first example of the hydraulic system according to embodiments of the present disclosure; and

FIGS. 6A-6E are various view of the second example of the hydraulic system according to embodiments of the present disclosure.

### DETAILED DESCRIPTION

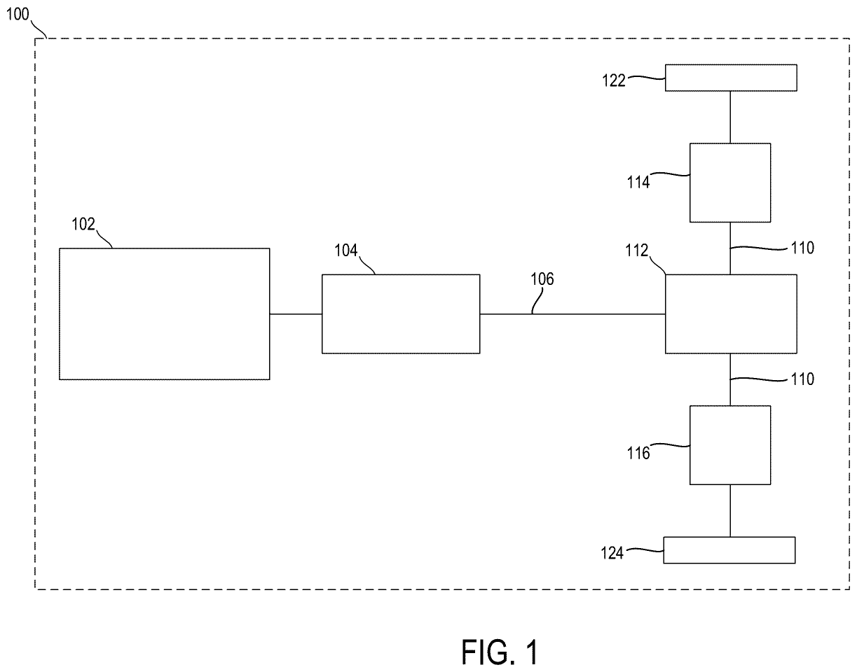

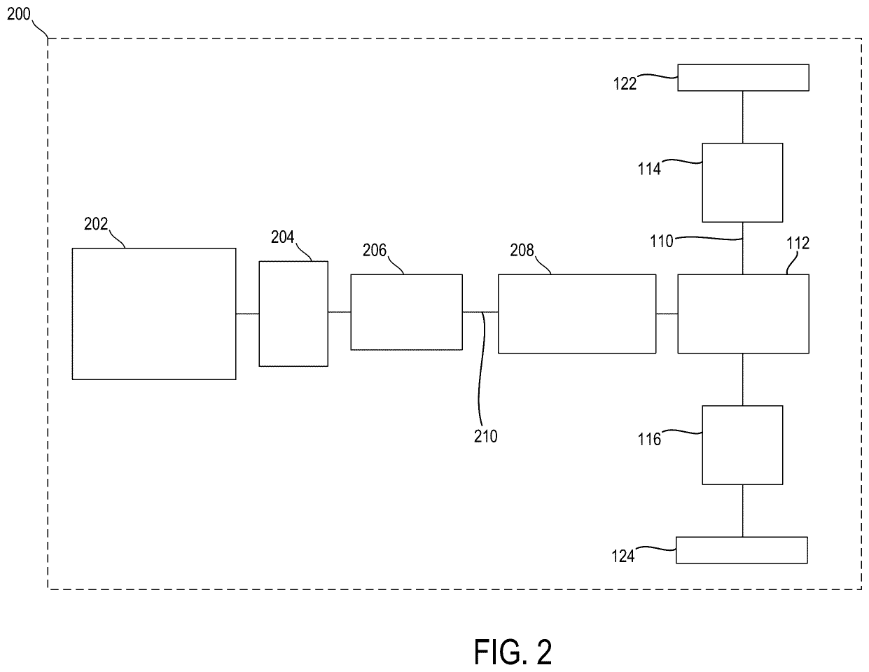

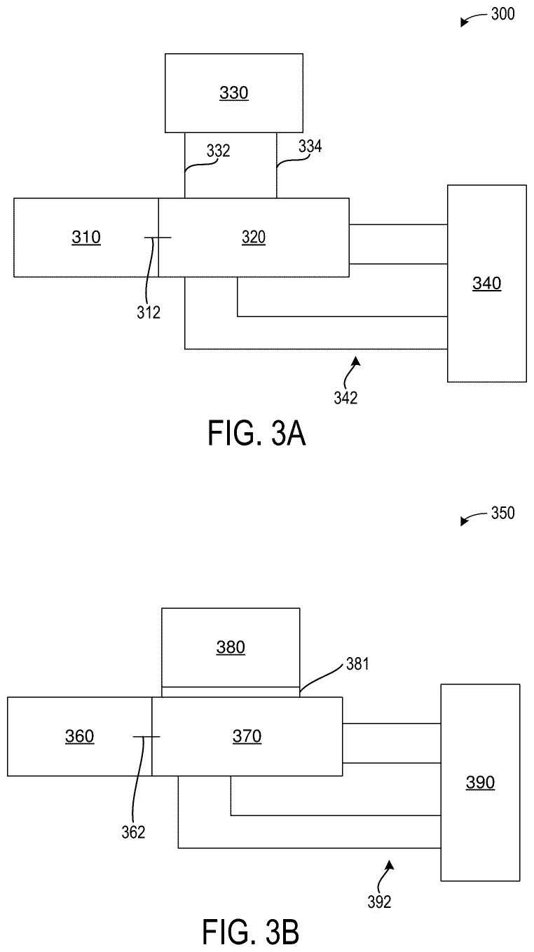

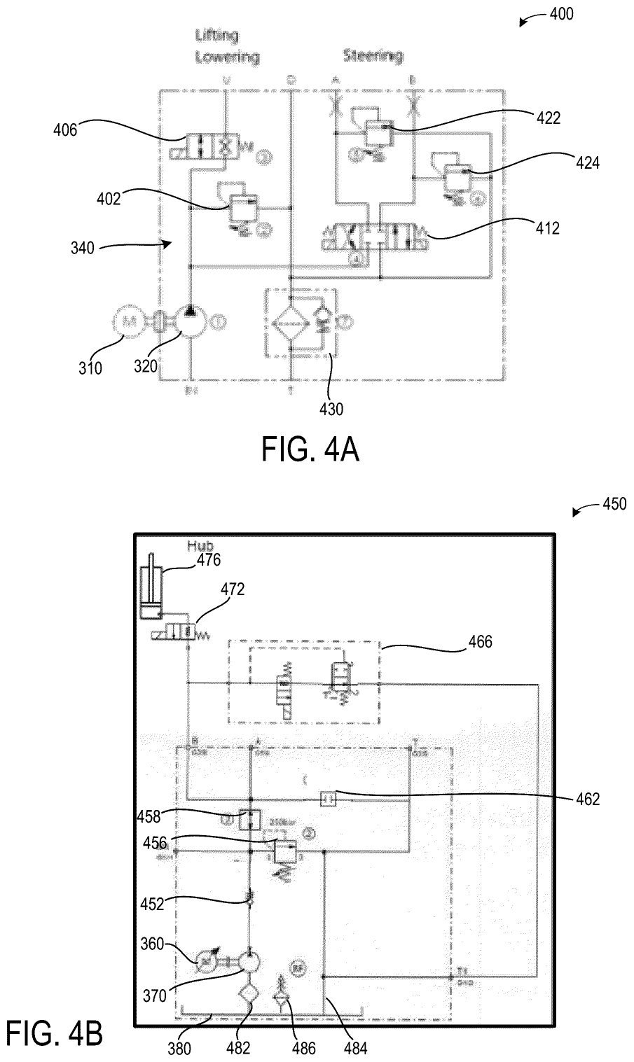

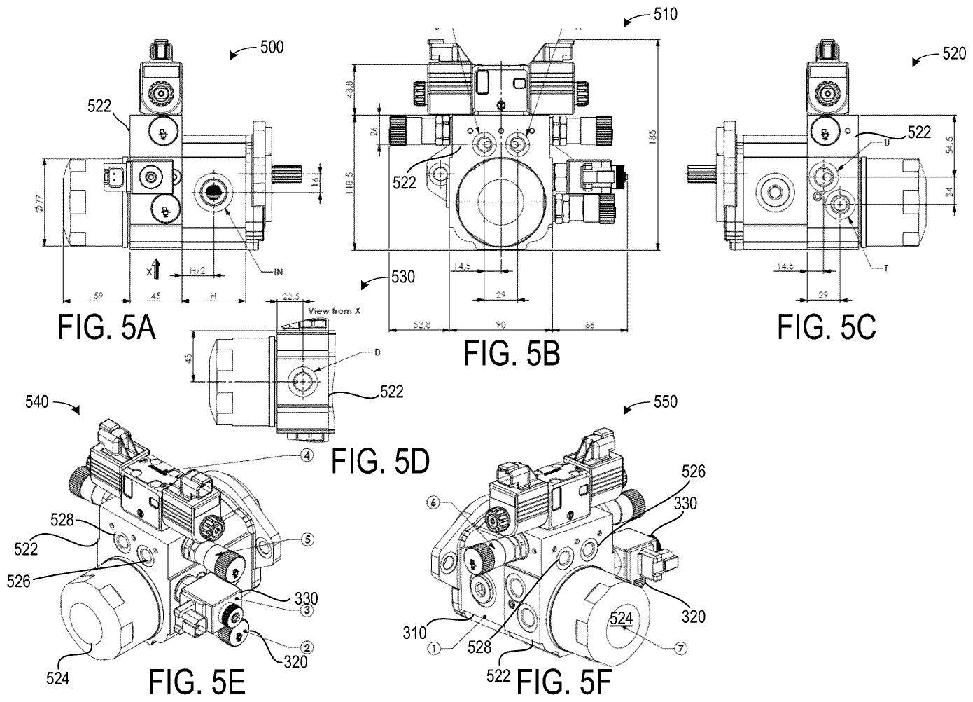

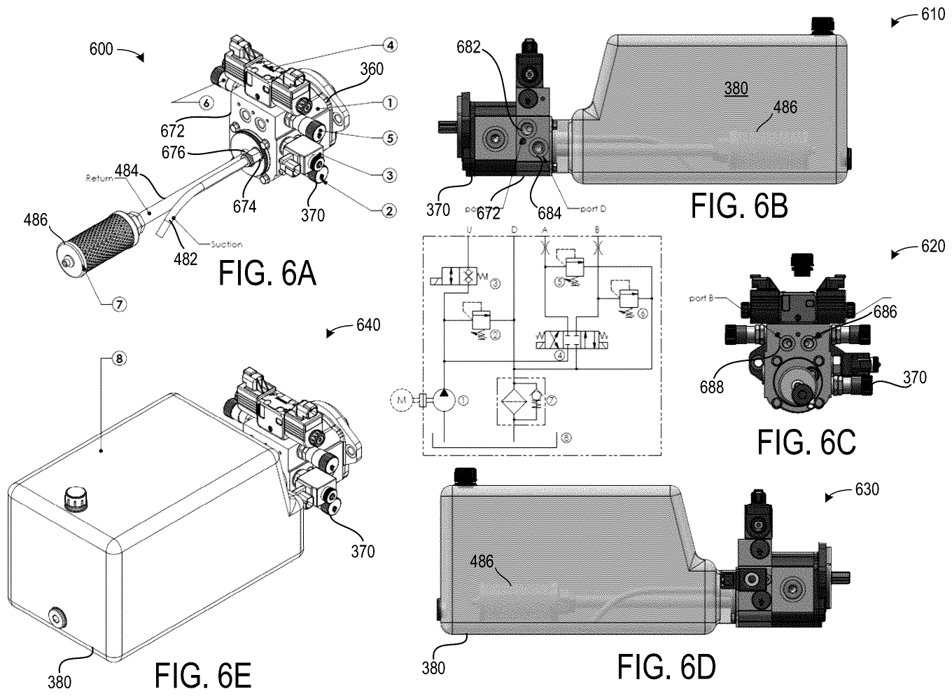

The following description relates to a hydraulic system of a mobile asset. In one example, the hydraulic system is separate from a drivetrain of the mobile asset, examples of which are shown in FIGS. 1 and 2. FIG. 3A is a first example of a hydraulic system arranged in a mobile asset, according to an embodiment of the present disclosure. FIG. 3B is a second example of a hydraulic system arranged in a mobile asset, according to an embodiment of the present disclosure. FIG. 4A is a schematic for a hydraulic system of a first type of the mobile asset according to embodiments of the present disclosure. FIG. 4B is a schematic for a hydraulic system of a second type of the mobile asset. FIGS. 5A-5F are various views of the first example of the hydraulic system according to embodiments of the present disclosure. FIGS. 6A-6E are various views of the second example of the hydraulic system according to embodiments of the present disclosure.

FIGS. 1-6E show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. It will be appreciated that one or more components referred to as being “substantially similar and/or identical” differ from one another according to manufacturing tolerances (e.g., within 1-5% deviation). FIGS. 5A-6E are shown approximately to scale, however, other dimensions may be used if desired.

Turning now to FIG. 1, an example of an off-highway vehicle 100 is shown. The off-highway vehicle 100 may include an engine 102 as a power source. The engine 102 is coupled to a transmission 104 via a drive shaft 106. The drive shaft 106 transfers power from the transmission 104 to a differential 112 arranged on a drive axle 110. The differential 112 transfers power to a first final drive 114 and a second final drive 116. In one example, the first final drive 114 and the second final drive 116 are a planetary gear assembly. The first final drive 114 may transmit power to a first wheel 122 of the drive axle 110 and the second final drive 116 may transmit power to a second wheel 124 of the drive axle 110.

The engine 102 and the transmission 104 may be fixed on a chassis. The drive shaft 106 may act as a structural member of the vehicle 100. In one example, the engine 102 may be an internal combustion engine configured to receive fuel and air in a combustion cylinder. The engine 102 may produce exhaust gases as a byproduct of combustion for rotating and/or powering one or more components of the off-highway vehicle 100.

Turning now to FIG. 2, an off-highway vehicle 200 is shown. The off-highway vehicle 200 may be similar to the off-highway vehicle 100 in that it includes the drive axle 110 comprising the differential 112, the first final drive 114, the second final drive 116, the first wheel 122, and the second wheel 124.

The off-highway vehicle 200 further includes an energy storage device 202 coupled to a motor control unit 204. The motor control unit 204 may be coupled to an electric motor 206. The electric motor 206 may transfer power to a transmission 208 via a drive shaft 210. The transmission 208 may be coupled to the differential 112.

Turning now to FIG. 3A, it shows an embodiment 300 that integrates into a single component, such as a pump 320, all the functions (e.g., controls) of a hydraulic system, except for the actuators and the tank. A pump cover (shown in FIGS. 5A-5F) integrates a plurality of hydraulic integrated circuit (HIC) functions. The HIC functions may include one or more of steering, lifting, and lowering. In one example, the HIC functions may include at least each of steering, lifting, and lowering. The advantage of the embodiment 300 is a to simplify the layout of hydraulic components included in the hydraulic system, which may be separate from a drivetrain, such as the drivetrains of FIGS. 1 and 2. The gear pump 320 may be coupled to an electric motor 310 and to a tank 330. The electric motor 310 may be identical to the electric motor 206 of FIG. 2. The pump 320 may output to a functions module 340. The tank 330 may comprise plastic or steel or another material. By coupling each of the electric motor 310 and the tank 330 to the pump 320, a size of the hydraulic system may be reduced. This may optimize or reduce compartments of the aerial platforms and of the forklift because an external block, an external or semi-submerged spin-on filter in the tank, delivery and return pipes/hoses to the tank and of the connection fittings to blocks and filter are no longer demanded. Further benefits of the circuit hydraulics may include a reduction in pressure drops, a reduction of the internal surfaces of the circuit with less possibility of oil contamination and a lower possibility of oil leaks to the outside that produce environmental pollution.

The electric motor 310 may transfer power to the pump 320 via a shaft 312. The pump 320 may be directly coupled to the electric motor 310 such that the shaft 312 extends through a pump cover of the pump 320 and does not include a shaft housing. That is to say, the shaft 312 may be housed via the housing of the electric motor 310 and the housing of the pump 320.

The pump 320 may be fluidly coupled to the tank 330 via an inlet line 332 and a return line 334. The inlet line 332 may direct fluid from the tank 330 to the pump 320. The return line 334 may flow fluid back to the tank 330. In some examples, the return line 334 may flow fluid through a filter prior to mixing the fluid with fluid in the tank 330. In one example, the fluid is lubricant, such as oil. A plurality of lines 342 may extend from the pump 320 to the function module 340 for transferring fluid thereto.

Turning now to FIG. 3B, it shows an embodiment 350, which may be similar to the embodiment 300 of FIG. 3A, except that hydraulic passages of a tank 380 are integrated into the pump 370. In one example, the embodiment 350 illustrates a power pack, wherein the pump 370 is external to the tank 380 and coupled to each of an electric motor 360 and the tank 380. The pump 370 may output to a function module 390. The embodiment 350 may include a centering in a pump cover to mount the tank 380 and a sealing element, such as an O-ring, gasket, or other device to block oil from leaking between the tank 380 and the pump cover. In this way, external connections between the tank 380 and the pump 370 may be removed, further simplifying the system. A return filter may be submerged in the tank 380 and connected to the end cover with one of a hose, a pipe, or a fitting. An additional internal connection may provide a desired suction for the pump.

In one example, only the pump cover is modified while all the other components, including multiple pumps, remain unchanged to maintain the modularity of the displacements and architectures. The pump cover leads to a reduction of the overall dimensions of the pump relative to previous examples, which allow an optimization or reduction of the compartments of the off-highway vehicle since an external block, an external or semi-submerged spin-on filter in the tank, delivery and return pipes and/or hoses to the tank 380 and of the connection fittings to blocks and filter are no longer needed. The advantage of this layout compared to previous systems is that with the possibility of a direct connection of the pump 370 on the electric motor 360 it is possible to use pumps with different flanges such as SAE, European, and German but also all the groups available on the market with regard to flow rate and power (groups 0.5, 1, 1.5, 2 and 3) to improve performance, the transmitted torque, and longevity of the system. Various pump covers may be configured to meet different flow rates and power outputs. For example, a first pump cover may be configured for groups 0.5-1, a second pump cover may be configured for groups 1.5-2, and a third pump cover may be configured for group 3. In one example, each of the various pump covers may use the same centering despite having different power outputs. An additional technical advantage of the circuit hydraulics may include a reduction in pressure drops, a reduction of the internal surfaces of the circuit with less possibility of oil contamination and a lower possibility of oil leaks to the outside that produce environmental pollution.

In one example, a group 1 flow rate includes a flow rate up to 25 L/min. A group 2 flow rate includes a flow rate up to 60 L/min. A group 3 flow rate includes a flow rate up to 180 L/min. Non-whole number groups may include flow rates between corresponding whole number groups.

The electric motor 360 may transfer power to the pump 370 via a shaft 362. The pump 370 may be directly coupled to (e.g., mounted to) the electric motor 360 such that the shaft 362 extends through a pump cover of the pump 370 and does not include a shaft housing. That is to say, the shaft 362 may be housed via the housing of the electric motor 360 and the housing of the pump 370.

The pump 370 may be directly coupled to the tank 380 via interface 381. The interface may include ports arranged in a pump cover of the pump 370 that may fluidly couple the pump 370 to an interior of the tank 380. An inlet line may direct fluid from the interior of the tank 380 to the pump 370 and a return line may direct fluid from the pump 370 to a filter arranged in the interior of the tank. The interface may position the pump 370 such that the pump 370 is directly coupled to an outer face of the tank 380. A plurality of lines 392 may extend from the pump 370 to the function module 390.

That is to say, in the example of FIG. 3B, the pump cover of the pump 370 may include interfaces for directly mounting the electric motor 360 and the tank 380 to the pump 370. The packaging size of the system including the electric motor 360, the pump 370, and the fuel tank 380 may be reduced relative to previous configurations that do not mount the electric motor 360 and/or the fuel tank 380 to the pump 370.

Turning to FIGS. 4A and 4B, they show schematics for a first embodiment 400 and a second embodiment 450 of a hydraulic circuit. The first embodiment 400 may represent a hydraulic circuit for a scissor lift and the second embodiment 450 may represent a hydraulic circuit for a fork lift. The first embodiment 400 may include the electric motor 310, the pump 320, and a filter 430 of a fuel tank, such as fuel tank 330 of FIG. 3A. The pump 320 may output to various components of the function module 340 and a plurality of valves including a first valve 402, a second valve 406, a third valve 412, a fourth valve 422, and a fifth valve 424.

The first valve 402 may be a pressure relieve valve configured to establish a threshold pressure of the hydraulic circuit. The threshold pressure may be a non-zero, positive number. The second valve 406 may be a double-sealed solenoid valve configured to control a lifting and/or lowering of a component of the vehicle, such as a scissor lift. The third valve 412 may be a multi-way multi-position valve configured to control steering. The fourth and fifth valves 422, 424 may be anti-shock valves configured to limit pressure peaks due to impacts during steering.

The second embodiment 450 may include the electric motor 360, the pump 370, and the tank 380. The pump 370 may receive fluid from the tank 380 via an inlet line 482. Fluid may return to the tank 380 via a return line 484. The tank 380 may include an oil tank filler cap with filter 486 submerged in the tank 380. The pump 370 may flow hydraulic fluid to the function module (e.g., function module 390 of FIG. 3B). The pump 370 may include a first valve 452, a second valve 456, a first plug 458, a second plug 462, a third valve 466, a fourth valve 472, and a cylinder 476. The first valve 452 may be a check valve for mitigating degradation by controlling an overall pressure of the pump 370. The second valve 456 may be a pressure relief valve configured to establish a threshold pressure of the hydraulic circuit. The threshold pressure is a non-zero, positive number. The first plug 458 may be a two-way plug and the second plug 462 may be a fully sealed plug. The third valve 466 may be an electrically operated flow control valve configured to regulate a descent speed of the cylinder 476 via gravity when the pump 370 is deactivated and the fourth valve 472 is energized. The fourth valve 472 may be a solenoid valve and may be configured to allow the cylinder 476 to rise without exciting, which may include oil passing therethrough without lifting a poppet valve thereof. In one example, when the pump 370 is deactivated and the fourth valve 472 is not energized, the cylinder 476 may remain in a given position. When the pump 370 is deactivated and the fourth valve 472 is energized, the third valve 468 may allow the cylinder 476 to descend (e.g., decrease speed) at a controlled rate based on gravity.

Turning now to FIGS. 5A-5F, they show various views of the pump 320. The pump 320 as illustrated in FIGS. 5A-5F may be used in the first embodiment 400 and/or the second embodiment 450. FIG. 5A shows a side-on view 500 of a tank side of the pump 320. FIG. 5B shows a face-on view 510 of a filter side of the pump 320. FIG. 5C shows a side-on view 520 of a second side of the pump 320, opposite the first side. FIG. 5D shows a bottom-up view 530 of the pump 320. FIG. 5E shows a first perspective view 540 including the tank side and the filter side of the pump 320. FIG. 5F shows a second perspective view 550 including the second side and the tank side of the pump 320.

As shown, the pump 320 may include a pump cover 522 comprising a plurality of ports. The pump cover 522 may be directly coupled to a return filter 524 and to the tank 330. As such, the inlet line 332 and the return line 334 extend within the pump cover 522. The pump cover 522 may further comprises a plurality of outlets 526 and 528 configured to output hydraulic fluid to the function module (e.g., function module 340 of FIG. 3A).

Turning now to FIGS. 6A-6E, they show various views of the pump 370. The pump 370 as illustrated in FIGS. 6A-6E may be used in the first embodiment 400 and/or the second embodiment 450. FIG. 6A shows a perspective view 600 of a pump cover 672 and an interior of the tank 380. FIG. 6B shows a side-on view 610 of the pump 370, the pump cover 672, and the tank 380. FIG. 6C shows a face-on view 620 from a tank side of the pump cover 672. FIG. 6D shows a side-on view 640 illustrating the pump 370, the tank 380, and the electric motor 360. FIG. 6E shows a perspective view 640 of the tank 380 and the pump cover 672.

The pump cover 672 may be directly coupled to each of the electric motor 360, through the pump 370, and to the tank 380. The pump cover 672 may include an inlet port 674 and a return port 676 coupled to the inlet line 482 and the return line 484. The filter 486 is arranged in an interior of the tank 380. The return line 484 may be coupled to the filter 486 and directly to the pump 370 via the return port 676. The pump cover 672 may comprise a flange or other coupling element to directly couple the electric motor 360 to the pump 370. In one example, the pump cover 672 may be directly coupled to the electric motor 360 and the pump 370 due to an absence of an in-line connection between the tank 380 and the filter 486. In this way, the pump cover 672 may be integrated into a group 1 or larger pump, which may not be achieved by previous examples in the art.

The disclosure provides support for a system including a gear pump coupled to an electric motor and a tank, the gear pump comprising an end cover with a hydraulic integrated circuit (HIC) arranged therein. A first example of the system further includes where an inlet line and a return line extend directly between the tank and the gear pump. A second example of the system, optionally including the first examples, further includes where the return line comprises a filter. A third example of the system, optionally including one or more of the previous examples, further includes where the HIC controls one or more of steering, lifting, and lowering. A fourth example of the system, optionally including one or more of the previous examples, further includes where the gear pump is arranged in an off-highway vehicle. A fifth example of the system, optionally including one or more of the previous examples, further includes where a shaft extends from the electric motor to the gear pump, and wherein the shaft is free of a shaft housing. A sixth example of the system, optionally including one or more of the previous examples, further includes where the electric motor is mounted directly to a pump cover of the pump. A seventh example of the system, optionally including one or more of the previous examples, further includes where the fuel tank is mounted directly to a pump cover of the pump.

The disclosure provides additional support for an off-highway vehicle including a gear pump coupled to an electric motor, the gear pump comprising an end cover with a hydraulic integrated circuit (HIC) arranged therein and a tank directly coupled to the gear pump. A first example of the off-highway vehicle further includes where the gear pump comprises an inlet port coupled to an inlet line arranged in an interior of the tank. A second example of the off-highway vehicle, optionally including the first example, further includes where the gear pump comprises an outlet port coupled to a return line extending from the outlet port to a filter arranged in the interior of the tank. A third example of the off-highway vehicle, optionally including one or more of the previous examples, further includes where electric motor is directly mounted to the gear pump. A fourth example of the off-highway vehicle, optionally including one or more of the previous examples, further includes where the gear pump is outside an interior of the tank. A fifth example of the off-highway vehicle, optionally including one or more of the previous examples, further includes where the off-highway vehicle is a scissor lift or a fork lift. A sixth example of the off-highway vehicle, optionally including one or more of the previous examples, further includes where a plurality of lines fluidly coupling the tank to the gear pump are housed by a pump cover of the gear pump.

The disclosure provides further support for an off-highway vehicle including a pump comprising a pump cover comprising a plurality of mounting points and an electric motor directly mounted to the pump cover, wherein a shaft extending from the electric motor to the pump is housed via only an electric motor housing and the pump cover. A first example of the off-highway vehicle further includes where a tank is directly mounted to the pump cover, and wherein lines fluidly coupling the tank to the pump are housing via only a tank housing and the pump cover. A second example of the off-highway vehicle, optionally including the first example, further includes where the pump further comprises an end cover comprising a hydraulic integrated circuit (HIC) integrally arranged within the end cover. A third example of the off-highway vehicle, optionally including one or more of the previous examples, further includes where the HIC controls steering, lifting, and lowering of a component of the off-highway vehicle. A fourth example of the off-highway vehicle, optionally including one or more of the previous examples, further includes where a plurality of valves is arranged within the pump.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A system, comprising:
a gear pump coupled to an electric motor and a tank, the gear pump comprising an end cover with a hydraulic integrated circuit (HIC) arranged therein.

2. The system of claim 1, wherein an inlet line and a return line extend directly between the tank and the gear pump.

3. The system of claim 2, wherein the return line comprises a filter.

4. The system of claim 2, wherein the HIC controls one or more of steering, lifting, and lowering.

5. The system of claim 1, wherein the gear pump is arranged in an off-highway vehicle.

6. The system of claim 1, wherein a shaft extends from the electric motor to the gear pump, and wherein the shaft is free of a shaft housing.

7. The system of claim 1, wherein the electric motor is mounted directly to a pump cover of the pump.

8. The system of claim 1, wherein the fuel tank is mounted directly to a pump cover of the pump.

9. An off-highway vehicle, comprising:
a gear pump coupled to an electric motor, the gear pump comprising an end cover with a hydraulic integrated circuit (HIC) arranged therein; and
a tank directly coupled to the gear pump.

10. The off-highway vehicle of claim 9, wherein the gear pump comprises an inlet port coupled to an inlet line arranged in an interior of the tank.

11. The off-highway vehicle of claim 10, wherein the gear pump comprises an outlet port coupled to a return line extending from the outlet port to a filter arranged in the interior of the tank.

12. The off-highway vehicle of claim 9, wherein electric motor is directly mounted to the gear pump.

13. The off-highway vehicle of claim 9, wherein the gear pump is outside an interior of the tank.

14. The off-highway vehicle of claim 9, wherein the off-highway vehicle is a scissor lift or a fork lift.

15. The off-highway vehicle of claim 9, wherein a plurality of lines fluidly coupling the tank to the gear pump are housed by a pump cover of the gear pump.

16. An off-highway vehicle, comprising:
a pump comprising a pump cover comprising a plurality of mounting points; and
an electric motor directly mounted to the pump cover, wherein a shaft extending from the electric motor to the pump is housed via only an electric motor housing and the pump cover.

17. The off-highway vehicle of claim 16, wherein a tank is directly mounted to the pump cover, and wherein lines fluidly coupling the tank to the pump are housing via only a tank housing and the pump cover.

18. The off-highway vehicle of claim 16, wherein the pump further comprises an end cover comprising a hydraulic integrated circuit (HIC) integrally arranged within the end cover.

19. The off-highway vehicle of claim 18, wherein the HIC controls steering, lifting, and lowering of a component of the off-highway vehicle.

20. The off-highway vehicle of claim 16, wherein a plurality of valves is arranged within the pump.
